(19) United States
(12) Patent Application Publication
(10) Pub. No.: US 2008/0025033 A1
(43) Pub. Date: Jan. 31, 2008

(54) Vessel Made of Internally Illuminated Light-Transmitting Material

(76) Inventor: John De Groot, VG Weesp (NL)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/597,628

(22) PCT Filed: Jan. 6, 2005
(86) PCT No.: PCT/NL05/00003

§ 371 Date: Nov. 27, 2006

(30) Foreign Application Priority Data
May 26, 2004 (NL) 1026276

(51) Int. Cl. B60Q 1/00; F21V 21/08

(52) U.S. Cl. 362/477; 362/108

(57) ABSTRACT

What is disclosed is a vessel (1) provided with one or more light sources (3), wherein the vessel is at least partially made of an at least slightly light-transmitting material, and wherein said at least one light source is connected to the material in such a manner that the light is spread within the material. The advantage of the vessel is that the—usually supporting—material of which the vessel is built up, which material is already present anyway in some types of boats, such as inflatable boats, can be utilized in a multifunctional manner, so that it can be used as a light carrier or a light diffuser as well. As a result, the vessel attracts more attention, but it can also be used more effectively as a conspicuous, eye-catching craft, which makes it optimally suitable for use as, for example, an advertising craft or a warning buoy.

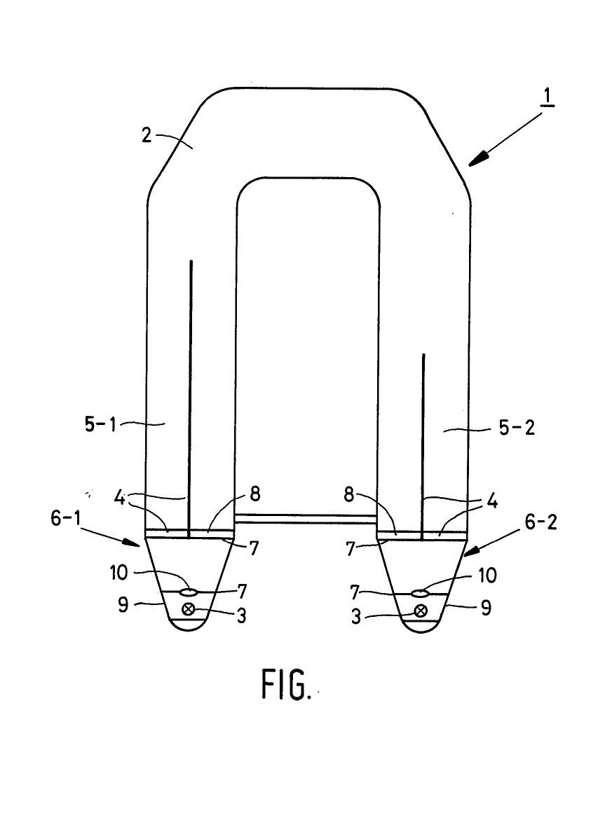

The present invention relates to a vessel provided with one or more light sources.

Known vessels are fitted with night lighting mounted on or to the vessel so as to ensure that the vessel will be noticed.

The object of the present invention is to provide the vessel with features that will make it attract even more attention.

In order to accomplish that object, the vessel according to the invention is characterized in that the vessel is at least partially made of an at least slightly light-transmitting material, and in that said at least one light source is connected to the material in such a manner that the light is spread within the material.

The advantage of the vessel according to the invention is the fact that the—usually supporting—material of which the vessel is built up, which material is already present anyway in some types of boats, such as inflatable boats, is utilized in a multifunctional manner, so that it can be used as an internal light carrier or a light diffuser as well. As a result, the vessel attracts more attention, but it can also be used more effectively without external features as a conspicuous, eye-catching craft, which makes it optimally suitable for use as, for example, an advertising craft or a buoy that shows up clearly. Insofar as inflatable objects are or are not present on the vessel, the use of said objects as light carriers or light diffusers will enable them to perform their eye-catching advertising or rescue function more adequately.

The vessel according to the present invention will now be explained in more detail with respect to the figures below, in which like parts are indicated by the same reference numerals.

The only FIGURE shows a possible embodiment of the vessel according to the invention.

The FIGURE shows a vessel 1, an inflatable vessel 1 in the illustrated embodiment, which may or may not be provided with a bottom. The illustrated vessel 1 comprises one tube 2 filled with a fairer as the light-transmitting medium, which tube is at least partially, but possibly also entirely, made of an at least slightly light-transmitting material. Said material may partially comprise a light window, which transmits light without impediment and which is connected to one or more light sources 3. The light that is emitted into the tube or tubes 2 by the light source or light sources 3 spreads out therein, with the whole being perceived as a completely diffusely illuminated unit from the outside. In this way also a (usually inflatable) object, which is at least partially made of an at least slightly light-transmitting material, can be illuminated in its entirety in a space-saving manner.

The vessel 1 may be divided into one or more light chambers 5-1, 5-2 (to be indicated below with reference numeral 5) by a more or less non-translucent (if desired) partition 4 within a tube 2, which light chambers are internally irradiated by light from one or more respective light sources. Said light sources 3 may each emit light of a different colour, as a result of which each of the light chambers 5 that are present will have its own colour.

In the illustrated embodiment, the light sources 3 are mounted to one or more ends 6-1, 6-2 of the tube 2. As the figure furthermore shows in more detail, a screw unit 7 is present at each end 6 of the tube 2. Present in said unit 7 are one or more light sources 3. The screw unit 7 may comprise a ring 8 to be provided on the material at the end 6, to which a cap 9 can be fixed, e.g. by means of screw thread. Present in said cap 9 is the light source and possibly a current source (not shown), for example a battery or a set of batteries for supplying power to the light sources 3.

At the location of the ring 8, for example, the vessel 1 may be provided with a lens system 10, which is usually disposed in the screw unit 7, which lens system is positioned between the light source 3 and the tube 2 in a part of the partition 4. As a result, the light being emitted into the light chamber 5 in question by the light source 3 is concentrated or spread, depending on what is required. Such a whole can be mounted, for example in modular form, on existing vessels if desired. The lens, which may be made of plastic material, may be coloured. The light source may also comprise one or more LED's, which usually each emit light of a different colour, which LED's give off little heat but which emit a great deal of light with a high degree of efficiency, so that relatively small batteries to be built in will suffice. The light sources may emit the navigation colours red and green.

Light-reflecting means and/or illuminated advertising objects may be provided inside and/or outside the material of the vessel 1. The vessel 1 may be a lifeboat, a life raft, a life buoy, a light buoy, a floating advertising craft, a fishing boat or the like. When the vessel is used for diving purposes, underwater safety light may be provided if the bottom side of the tube 2 is light-transmitting.

In further advantageous embodiments the inflatable objects may be suitably sized and formed saving rafts, swimming or life jackets or vests, but also balloons, inflatable barriers or light beacons.

Alternatively one or more reflecting strips may be provided within and generally against the inner surface of the material of the possibly inflatable object, vessel 1 and/or tube(s) 2. This way the strip provides an additional visibility and light contrast, which is particularly but not exclusively important if darker colours, such as for example a red coloured light source or material is used.

1. A vessel provided with one or more light sources, characterized in that the vessel is at least partially made of an at least slightly light-transmitting material, and in that said at least one light source is connected to the material in such a manner that the light is spread within the material.

2. A vessel according to claim 1, characterized in that the vessel comprises one ore more light chambers, in which by light from one or more respective light sources spreads out.

3. A vessel according to claim 1 or 2, characterized in that the light sources have mutually different colours.

4. A vessel according to any one of the claims 1-3, characterized in that the vessel comprises at least one inflatable tube, which is at least partially made of said light-transmitting material.

5. A vessel according to claim 4, characterized in that the light sources are mounted to one or more ends of the tubes.

6. A vessel according to claim 5, characterized in that the vessel is provided with a screw unit at the end of said at least one tube, in which at least one or more light sources are present.

7. A vessel according to claim 6, characterized in that the vessel comprises a lens system disposed near the screw unit.

8. A vessel according to any one of the claims 1-7, characterized in that the light source comprises one or more LED's.

9. A vessel according to claim 8, characterized in that illuminated advertising objects are provided inside and/or outside the material.

10. A vessel according to any one of the claims 1-9, characterized in that said vessel is a lifeboat, a life raft, a life buoy, a light buoy, a floating advertising craft, a fishing boat or the like.

11. An inflatable object, such as a life jacket, which is at least partially made of an at least slightly light-transmitting material, wherein said at least one light source is connected to the material in such a manner that the light is spread within the material.
